(19) United States
(12) Patent Application Publication
(10) Pub. No.: US 2004/0158635 A1
(43) Pub. Date: Aug. 12, 2004

(54) Secure terminal transmission system and method

(75) Inventors: Chris Walls-Manning, Ramsey, MN (US); Mark Wickham, Eagan, MN (US)

Correspondence Address: Schwegman, Lundberg, Woessner & Kluth, P.A., P.O. Box 2938, Minneapolis, MN, 55402, US

(73) Assignee: Digi International Inc..

(21) Appl. No.: 10/350,679

(22) Filed: Jan. 23, 2003

(51) Int. Cl. G06F 15/16

(52) U.S. Cl. 709/226; 709/217

(57) ABSTRACT

A server has one or more communication ports. A host computer has a driver communicatively coupling the host computer to the server via a secure encrypted network connection. The driver emulates the one or more communication ports of the server by defining a corresponding local communication port for each of the communication ports of the server, and further includes an application programming interface (API) by which an application program executing on the host computer is granted full control of one of the communication ports of the server, including hardware and software flow control, as if the communication ports of the server were local to the host computer.

### FIELD OF THE INVENTION

The invention relates generally to computerized communication, and more specifically to a system and method for securing computerized device data transmission.

### BACKGROUND OF THE INVENTION

Although the first computers were used as standalone devices that processed the information brought to them and provided results to be taken away and utilized, modern computer networks have made the computer's role not only one of processing information but also one of communicating information.

Terminals such as serial TTY (teletype) devices were used as relatively unsophisticated devices to provide access to a computer, such that a user could use a terminal with little or no processing capability of its own to interact with a computer. Multiple TTY ports per computer enabled larger computers to provide processing capability for many users simultaneously, as well as connection of various other devices such as modems to exchange data between computers.

Technologies such as local area network (LAN) adapters, modems, and Internet connections have become commonplace elements in computers today, and enable computers to exchange information with each other in standardized and reliable ways. Access to control of remote computers, transfer of files, e-mail, and streaming multimedia are all common in modern networks, and are all relied upon in both personal communication and in conducting modern business.

A user of a local computer may wish to control a hardware port on a remote computer, such as where a user of a local computer wishes to control one or more serial ports on one or more remote computers to effectively provide control of a large number of serial ports from a local computer. Such a system is described in related U.S. Pat. No. 6,047,319, titled “Network Terminal Server with Full API Implementation”. Such a system would allow a single local computer to control via one or more remote computers a large number of serial ports, each of which may have a device such as a terminal attached. For example, a host computer may be linked via a network such as the Internet to one or more server computers, each of which has one or more serial ports, each serial port having a terminal such as a cash register connected thereto, such that the host computer effectively controls each of the cash register terminals via a virtual serial port implemented in a driver providing communication between the host and server computers.

But, because the link between the host and server computers of the above example may in some embodiments subject cash register data to Internet transmission that can be altered, removed, added, or otherwise interfered with via other Internet computers, a need exists for ensuring the integrity, privacy, and authenticity of data transmitted between a host computer and a server computer in such systems.

### SUMMARY OF THE INVENTION

The present invention in one embodiment comprises a server having one or more communication ports, and a host computer. The host computer has a driver communicatively coupling the host computer to the server via a secure encrypted network connection. The driver emulates the one or more communication ports of the server by defining a corresponding local communication port for each of the communication ports of the server, and further includes an application programming interface (API) by which an application program executing on the host computer is granted full control of one of the communication ports of the server, including hardware and software flow control, as if the communication ports of the server were local to the host computer.

### BRIEF DESCRIPTION OF THE FIGURES

FIG. 1 shows a networked retail store terminal configuration consistent with an embodiment of the present invention.

FIG. 2 is a flowchart illustrating a method of providing a secure encrypted virtual communications port, consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in one embodiment a server having a one or more communication ports, and a host computer. The host computer has a driver communicatively coupling the host computer to the server via a secure encrypted network connection. The driver emulates the communication ports of the server by defining a corresponding local communication port for each of the communication ports of the server, and further includes an application programming interface (API) by which an application program executing on the host computer is granted full control of one of the communication ports of the server, including hardware and software flow control, as if the communication ports of the server were local to the host computer.

Such a configuration provides secure control of server ports from a host computer, and therefore secure access to devices attached to such ports from the host computer. This enables a host computer in some embodiments to effectively address a larger number of communications ports and devices attached to communications ports than might be practical in a single computer system.

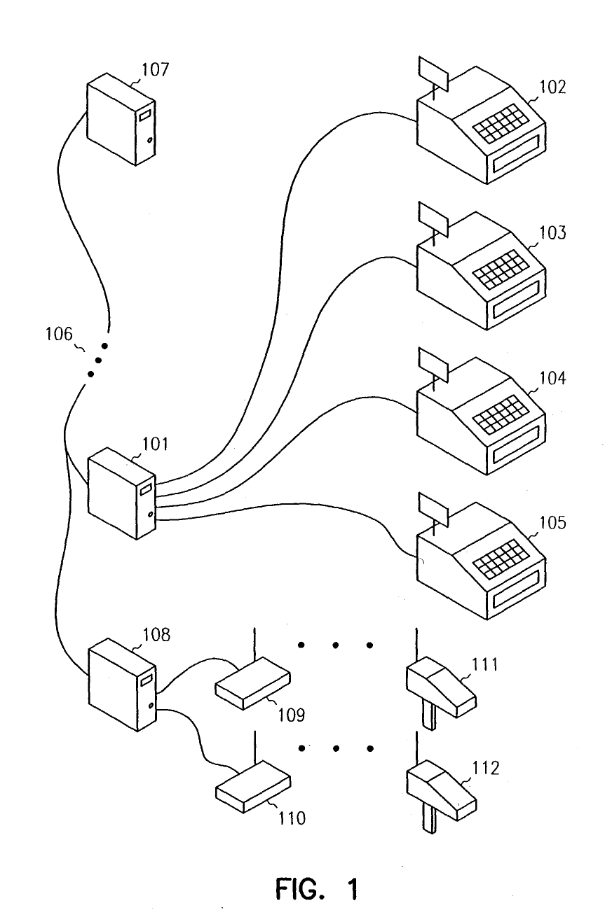

FIG. 1 illustrates one such example embodiment of the invention. A point-of-sale server 101 has four serial ports, each serial port connected to a point-of-sale terminal 102, 103, 104, or 105. The server is also connected via a network connection such as an Internet connection 106 to host computer 107, and to a terminal server such as data collection server 108. The data collection server 108 has two serial ports, each connected to a wireless data collection terminal controller 109 or 110 that are operable to communicate with wireless data terminals 111 and 112, respectively.

In operation, the host computer 107 establishes a secure encrypted connection to the POS server 101, and establishes a secure connection to the data collection server 108. The connections are established via a driver on the host computer that emulates the serial communications ports on the servers 101 and 108 by defining a corresponding communication port local to the host 107. A driver on the server computers 101 and 108 communicates with the driver on the host computer, and controls operation of the local server serial communication ports. The host computer driver includes an application programming interface (API) by which an application program executing on the host computer is granted full control of the serial communication ports on servers 101 and 108 via the drivers on the host and server computers. The host computer therefore has control of the serial communication ports on the servers 101 and 108, including hardware and software flow control, as if the communication ports of the server were local to the host computer.

As a further example, host computer 107 runs a point-of-sale and inventory control accounting system for managing retail store operation. Server 101 provides serial port connectivity to point of sale cash registers 102, 103, 104, and 105, and server 108 provides serial port connectivity to wireless data collection devices 111 and 112 via their respective wireless controllers 109 and 110. An application program running on host computer 107 controls each of the point of sale devices 102-105 and wireless data collection devices 111 and 112 by addressing a virtual serial port within 107. One example of addressing a virtual serial port within host computer 107 via an application programming interface (API) is described in greater detail in related U.S. Pat. No. 6,047,319, titled “Network Terminal Server with Full API Implementation”, which is hereby incorporated by reference. The host computer therefore can address the serial communications ports of servers 101 and 108, and the devices attached thereto, as if the communication ports of the server were local to the host computer.

This enables the host computer to control six local serial ports in this example, as well as the devices attached to each, with a single host application running on a single host computer system. The host system in this example will be operable to receive transaction data from the point of sale devices, and send pricing and other information to the point of sale devices. The host system will simultaneously be operable to receive data such as inventory data from wireless data collection devices 111 and 112, and will be operable to send data such as inventory and pricing information to these devices. Each of these connected devices is a terminal device for purposes of the invention, as are all other such communicating electronic devices.

In a further example, a greater number of servers such as 101 and 108 may be used in a retail store setting, as it may be desirable to control dozens of point of sale devices and other data collection devices within a retail setting. This is but one illustrative example of an environment in which the present invention may be utilized to facilitate communication between a host computer and a terminal device via a server and software drivers. Other applications such as process control and communications are also within the scope of the invention, which is limited only by the claims.

Configurations such as these provide the host with communication capability to terminal devices such as point of sale and data collection devices, but do not consider the security of such data. As discussed previously, network 106 will be in some embodiments of the invention the Internet or other public or insecure network, making authentication of connected devices and interception or alteration of data a concern. For example, in the retail application of FIG. 1, pricing or inventory information may be intercepted and altered or deleted as it travels over the Internet between the host computer and a point of sale device, resulting in inaccurate sale price or inventory control. The present invention provides for a secure encrypted network connection between the host and the one or more servers, thereby providing a greater degree of security for the data transmitted between the host and servers.

Protection of the data takes different forms in varying embodiments of the invention, including but not limited to various symmetric algorithms, public key algorithms, and one-way hash functions. Various embodiments of the invention rely on algorithms such as these being implemented in hardware or in software on the host computer 107 and on each of the one or more server computers 101 and 108, such as within a software driver executing on the respective computers. Other embodiments use SSL, or Secure Socket Layer, which is a secure protocol that supports a variety of encryption algorithms and functions.

A symmetric algorithm relies on agreement of a secret key before encryption, and the decryption key is either the same as or can be derived from the encryption key. Secrecy of the key or keys is vital to ensuring secrecy of the data in such systems, and the key must be securely distributed to the receivers before decryption such as via a secure key exchange protocol. Common symmetric algorithms include DES, 3DES or triple-DES, AES, Blowfish, Twofish, IDEA, RC2, RC4, and RC5.

Public key algorithms, or asymmetric algorithms, are designed so that the decryption key is different than and not easily derivable from the encryption key. The term “public key” is used because the encryption key can be made public without compromising the security of data encrypted with the encryption key. Anyone can therefore use the public key to encrypt a message, but only a receiver with the corresponding decryption key can decrypt the encoded data. The encryption key is often called the public key, and the decryption key is often called the private key in such systems. Common public key algorithms include RSA, Diffie-Hellman, and ElGamal.

One-way hash functions take an input string and derive a fixed length hash value. The functions are designed so that it is extremely difficult to produce an input string that produces a certain hash value, resulting in a function that is considered one-way. Data can therefore be checked for authenticity by verifying that the hash value resulting from a given one-way hash function is what is expected, making authentication of data relatively certain. Hash functions can be combined with other methods of encryption or addition of secret strings of text in the input string to ensure that only the intended parties can encrypt or verify data using the one-way hash functions. Common examples of one-way hash function encryption include MD2, MDC2, MD4, MD5, and SHA.

A variation on one-way hash functions is use of Message Authentication Codes, or MAC. A MAC comprises a one-way hash function that further includes a secret key, such that knowledge of the key is necessary to encode or verify a given set of data. MACs are particularly useful where the hash value would otherwise be subject to unauthorized alteration or replacement, such as when transmitted over a public network.

Any of the encryption methods described here and any other suitable encryption method may be used in various embodiments of the invention to protect data transmitted between the host computer and the server computers of the present invention, ensuring that the data transmitted between the host and server computers is authentic and secure. Many of the encryption methods listed above can be used for various authentication functions, such as key exchange, using an authentication agent, or using a challenge response.

Securing a network connection via encryption will utilize various applications of encryption technology to the network connection data in various embodiments of the invention. The network connection itself is encrypted to ensure confidentiality as the data travels across a network in some embodiments, and other embodiments use cryptographic techniques to ensure integrity or authenticity of the data. In further embodiments, various encryption methods are used to ensure the integrity of the network connection. Still other embodiments will utilize encryption in various combinations of applications including those discussed here and of other applications, all of which are within the scope of the invention.

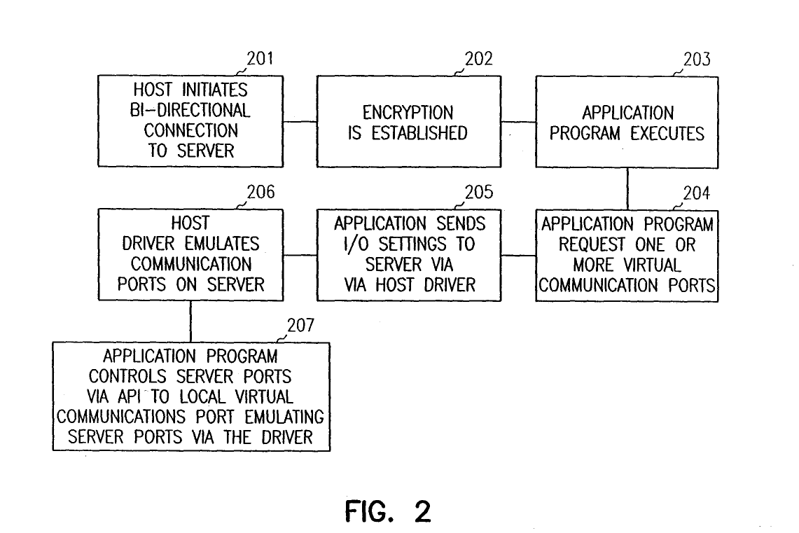

FIG. 2 is a flowchart of one example method of practicing the present invention on a system such as the example system of FIG. 1. The method shown here is implemented in one embodiment of the invention by software executing on a host computer and a server computer. At 201, the host computer initiates a bidirectional bytestream connection with a server over a network. In a further embodiment, the connection is established by a driver executing on the host computer, and is a TCP (Transmission Control Protocol) connection. At 202, encryption of the connection is established. At 203, an application program executes on the host.

At 204, the driver executing on the host computer maintains the connection between the host and server as the application program requests one or more virtual communication ports and creates one or more corresponding local virtual communication ports. At 205, the driver executing on the host computer optionally receives communication port I/O (input/output) settings from the application and communicates them to the server, which in turn configures the proper communication ports according to the I/O settings. At 206, the host driver emulates the one or more configured communications ports local to the server via a locally defined communications port. At 207, the application program executing on the host controls the server ports via an API to the local communications port emulated via the driver.

The example of FIG. 2 is but one example embodiment of the present invention. Some elements of various embodiments of the invention are described in greater detail in related U.S. Pat. No. 6,047,319, titled “Network Terminal Server with Full API Implementation”, which is hereby incorporated by reference.

The methods and systems described herein illustrate how the present invention can provide secure encrypted virtual communication ports on a host computer, ensuring security of data transmitted between the host computer and one or more server computers. Various embodiments of the invention will therefore provide varying degrees of protection for the data communicated between the host computer and the one or more server computers, providing authentication, integrity, and secrecy of the data as it travels between the host and servers.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

What is claimed is:

1. A system comprising:
a server having one or more communication ports; and
a host computer having a driver communicatively coupling the host computer to the server via a secure encrypted network connection, wherein the driver emulates the one or more communication ports of the server by defining a corresponding local communication port for one or more of the communication ports of the server, and further wherein the driver includes an application programming interface (API) by which an application program executing on the host computer is granted control of one or more of the communication ports of the server, as if the communication ports of the server were local to the host computer.

2. The system of claim 1, wherein the driver maintains a single network connection from the host computer to the server as the application program requests additional local communication ports from the driver.

3. The system of claim 1, wherein the driver defines a TTY device as the local communication port.

4. The system of claim 1, wherein the driver receives input/output (I/O) settings from the application program via the application programming interface, and further wherein the driver communicates the I/O settings to the server for configuring hardware characteristics of the granted server communication port.

5. The system of claim 1, wherein the server communication ports are serial ports.

6. The system of claim 1, wherein the server communication ports are Universal Serial Bus (USB) ports.

7. The system of claim 1, wherein the server communication ports are IEEE (Institute of Electrical and Electronic Engineers) 1394 (FireWire) ports.

8. The system of claim 1, wherein the network connection is a TCP connection.

9. The system of claim 1, wherein the secure encrypted network connection comprises encryption employed for confidentiality of network data.

10. The system of claim 1, wherein the secure encrypted network connection comprises encryption employed for authentication of network data.

11. The system of claim 1, wherein the secure encrypted network connection comprises encryption employed for message integrity of network data.

12. The system of claim 1, wherein the secure encrypted network connection comprises using a symmetric algorithm-encrypted connection to secure networked devices.

13. The system of claim 12, wherein the secure encrypted network connection comprises a 3DES-encrypted connection.

14. The system of claim 12, wherein a key exchange protocol is used to distribute a shared key for use with the symmetric encryption algorithm.

15. The system of claim 1, wherein the secure encrypted network connection comprises a public key-encrypted connection to ensure privacy.

16. The system of claim 1, wherein the secure encrypted network connection comprises use of a hash function to ensure message integrity.

17. The system of claim 1, wherein the secure encrypted connection comprises use of a message authentication code (MAC) to ensure message integrity.

18. The system of claim 1, wherein the secure encrypted connection comprises use of a public key algorithm to authenticate one or more networked devices.

19. The system of claim 1, wherein the secure encrypted connection comprises use of the secure socket layer (SSL) protocol.

20. A hardware device for a host computer, wherein the hardware device includes a driver that emulates one or more communications ports of a remote server that is communicatively coupled to the host computer via a secure encrypted network connection, wherein the driver defines a corresponding local communications port for one or more communication ports of the server and includes an application programming interface (API) by which an application program executing on the host computer is granted control of one or more of the communication ports of the server, as if the communication ports of the server were local to the host computer.

21. The hardware device of claim 20, wherein the driver maintains a single network connection from the host computer to the server as the application program requests additional local communication ports from the driver.

22. The hardware device of claim 20, wherein the driver defines a TTY device as the local communication port.

23. The hardware device of claim 20, wherein the driver receives input/output (I/O) settings from the application program via the application programming interface, and further wherein the driver communicates the I/O settings to the server for configuring hardware characteristics of the granted server communication port.

24. The hardware device of claim 20, wherein the server communication ports are serial ports.

25. The hardware device of claim 20, wherein the server communication ports are Universal Serial Bus (USB) ports.

26. The hardware device of claim 20, wherein the server communication ports are IEEE (Institute of Electrical and Electronic Engineers) 1394 (FireWire) ports.

27. The hardware device of claim 20, wherein the network connection is a TCP connection.

28. The hardware device of claim 20, wherein the secure encrypted network connection comprises encryption employed for confidentiality of network data.

29. The hardware device of claim 20, wherein the secure encrypted network connection comprises encryption employed for authentication of network data.

30. The hardware device of claim 20, wherein the secure encrypted network connection comprises encryption employed for message integrity of network data.

31. The hardware device of claim 20, wherein the secure encrypted network connection comprises using a symmetric algorithm-encrypted connection to authenticate networked devices.

32. The hardware device of claim 31, wherein the secure encrypted network connection comprises a 3DES-encrypted connection.

33. The hardware device of claim 31, wherein a key exchange protocol is used to distribute a shared key for use with the symmetric encryption algorithm.

34. The hardware device of claim 20, wherein the secure encrypted network connection comprises a public key-encrypted connection to ensure privacy.

35. The hardware device of claim 20, wherein the secure encrypted network connection comprises use of a hash function to ensure message integrity.

36. The hardware device of claim 20, wherein the secure encrypted connection comprises use of a message authentication code (MAC) to ensure message integrity.

37. The hardware device of claim 20, wherein the secure encrypted connection comprises use of a public key algorithm to authenticate one or more networked devices.

38. The hardware device of claim 20, wherein the secure encrypted connection comprises use of the secure socket layer (SSL) protocol.

39. A machine-readable medium with instructions thereon, the instructions when executed operable to cause a host computerized system to:
communicatively couple to the server via a secure encrypted network connection via a driver, wherein the driver emulates at least one communication port of the server by defining a corresponding local communication port for one or more of the at least one communication ports of the server, and further wherein the driver includes an application programming interface (API) by which an application program executing on the host computer is granted control of at least one communication port of the server, as if the at least one communication port of the server were local to the host computer.

40. The machine-readable medium of claim 39, wherein the driver maintains a single network connection from the host computer to the server as the application program requests additional local communication ports from the driver.

41. The machine-readable medium of claim 39, wherein the driver defines a TTY device as the local communication port.

42. The machine-readable medium of claim 39, wherein the driver receives input/output (I/O) settings from the application program via the application programming interface, and further wherein the driver communicates the I/O settings to the server for configuring hardware characteristics of the granted server communication port.

43. The machine-readable medium of claim 39, wherein the server communication ports are serial ports.

44. The machine-readable medium of claim 39, wherein the server communication ports are Universal Serial Bus (USB) ports.

45. The machine-readable medium of claim 39, wherein the server communication ports are IEEE (Institute of Electrical and Electronic Engineers) 1394 (FireWire) ports.

46. The machine-readable medium of claim 39, wherein the network connection is a TCP connection.

47. The machine-readable medium of claim 39, wherein the secure encrypted network connection comprises encryption employed for confidentiality of network data.

48. The machine-readable medium of claim 39, wherein the secure encrypted network connection comprises encryption employed for authentication of network data.

49. The machine-readable medium of claim 39, wherein the secure encrypted network connection comprises encryption employed for message integrity of network data.

50. The machine-readable medium of claim 39, wherein the secure encrypted network connection comprises using a symmetric algorithm-encrypted connection to authenticate networked devices.

51. The machine-readable medium of claim 50, wherein the secure encrypted network connection comprises a 3DES-encrypted connection.

52. The machine-readable medium of claim 50 wherein a key exchange protocol is used to distribute a shared key for use with the symmetric encryption algorithm.

53. The machine-readable medium of claim 39, wherein the secure encrypted network connection comprises a public key-encrypted connection to ensure privacy.

54. The machine-readable medium of claim 39, wherein the secure encrypted network connection comprises use of a hash function to ensure message integrity.

55. The machine-readable medium of claim 39, wherein the secure encrypted connection comprises use of a message authentication code (MAC) to ensure message integrity.

56. The machine-readable medium of claim 39, wherein the secure encrypted connection comprises use of a public key algorithm to authenticate one or more networked devices.

57. The machine-readable medium of claim 39, wherein the secure encrypted connection comprises use of the secure socket layer (SSL) protocol.

58. A machine-readable medium with instructions thereon, the instructions when executed operable to cause a computerized server system to:
communicatively couple to a host via a secure encrypted network connection via a driver, wherein the driver emulates at least one communication port of the server to the host such that an application program executing on the host computer may be granted control of at least one communication port of the server, as if the at least one communication port of the server were local to the host computer.

59. The machine-readable medium of claim 58, wherein the driver maintains a single network connection from the host computer to the server as the application program requests additional local communication ports from the driver.

60. The machine-readable medium of claim 58, wherein the driver defines a TTY device as the local communication port.

61. The machine-readable medium of claim 58, wherein the driver receives input/output (I/O) settings from the application program via the application programming interface, and further wherein the driver communicates the I/O settings to the server for configuring hardware characteristics of the granted server communication port.

62. The machine-readable medium of claim 58, wherein the server communication ports are serial ports.

63. The machine-readable medium of claim 58, wherein the server communication ports are Universal Serial Bus (USB) ports.

64. The machine-readable medium of claim 58, wherein the server communication ports are IEEE (Institute of Electrical and Electronic Engineers) 1394 (FireWire) ports.

65. The machine-readable medium of claim 58, wherein the network connection is a TCP connection.

66. The machine-readable medium of claim 58, wherein the secure encrypted network connection comprises encryption employed for confidentiality of network data.

67. The machine-readable medium of claim 58, wherein the secure encrypted network connection comprises encryption employed for authentication of network data.

68. The machine-readable medium of claim 58, wherein the secure encrypted network connection comprises encryption employed for message integrity of network data.

69. The machine-readable medium of claim 58, wherein the secure encrypted network connection comprises using a symmetric algorithm-encrypted connection to authenticate networked devices.

70. The machine-readable medium of claim 69, wherein the secure encrypted network connection comprises a 3DES-encrypted connection.

71. The machine-readable medium of claim 69, wherein a key exchange protocol is used to distribute a shared key for use with the symmetric encryption algorithm.

72. The machine-readable medium of claim 58, wherein the secure encrypted network connection comprises a public key-encrypted connection to ensure privacy.

73. The machine-readable medium of claim 58, wherein the secure encrypted network connection comprises use of a hash function to ensure message integrity.

74. The machine-readable medium of claim 58, wherein the secure encrypted connection comprises use of a message authentication code (MAC) to ensure message integrity.

75. The machine-readable medium of claim 58, wherein the secure encrypted connection comprises use of a public key algorithm to authenticate one or more networked devices.

76. The machine-readable medium of claim 58, wherein the secure encrypted connection comprises use of the secure socket layer (SSL) protocol.

77. A system comprising:
a server having one or more communication ports; and
a host computer having a driver communicatively coupling the host computer to the server via a secure encrypted network connection, wherein the driver emulates the one or more communication ports of the server by defining a corresponding local communication port for one or more of the communication ports of the server, and further wherein the driver includes an application programming interface (API) by which an application program executing on the host computer is granted control of one or more of the communication ports of the server, as if the communication ports of the server were local to the host computer, the secure encrypted connection providing confidentiality, authentication, and message integrity via one or more of SSL, Diffie-Hellman, public key, one-way hash function, or symmetric key encryption.

78. A machine-readable medium with instructions thereon, the instructions when executed operable to cause a host computerized system to:
communicatively couple to the server via a secure encrypted network connection via a driver, wherein the driver emulates at least one communication port of the server by defining a corresponding local communication port for one or more of the at least one communication ports of the server, and further wherein the driver includes an application programming interface (API) by which an application program executing on the host computer is granted control of at least one communication port of the server, as if the at least one communication port of the server were local to the host computer, the secure encrypted connection providing confidentiality, authentication, and message integrity via one or more of SSL, Diffie-Hellman, public key, one-way hash function, or symmetric key encryption.
